(19) United States
(12) Patent Application Publication
(10) Pub. No.: US 2025/0251543 A1
(43) Pub. Date: Aug. 7, 2025

(54) MITIGATING CROSS-TALK IN MULTI-CORE OPTICAL FIBER UNDER MICRO-BENDING

(71) Applicant: OFS Fitel, LLC, Norcross, GA (US)

(72) Inventors: Alan H McCurdy, Duluth, GA (US); David W Peckham, Lawrenceville, GA (US); Roman Shubochkin, Arlington, MA (US)

(73) Assignee: OFS Fitel, LLC, Norcross, GA (US)

(21) Appl. No.: 18/686,468

(22) PCT Filed: Oct. 12, 2022
(86) PCT No.: PCT/US2022/046352

§ 371 Date: Feb. 26, 2024

(51) Int. Cl. G02B 6/02

(52) U.S. Cl. CPC G02B 6/02042; G02B 6/02285

(57) ABSTRACT

In an optical fiber comprising a central axis (z) with a cladding that extend along z and a coating that is disposed about the cladding, a twist with a twist period (τ) is imparted on the optical fiber about z. The twist mitigates micro-bend-induced cross-talk. The cladding comprises a substantially circular axial cross section. The substantially circular axial cross-section comprises a cladding center and a cladding outer diameter (ODclad). Multiple cores (e.g., a first core, a second core, etc.) are disposed within the cladding. At least one core is disposed helically about z to form a helical core, with the helical core comprising a helical pitch (p) that is approximately equal to τ (meaning, p≈τ). The twist has a twist period (τ) that is less than 9.1 centimeters (meaning, τ<9.1 cm).

### BACKGROUND

### Field of the Disclosure

The present disclosure relates generally to optical fibers and, more particularly, to multi-core optical fibers.

### Description of Related Art

Those having skill in the art of optical fibers understand that there are significant differences between macro-bending effects and micro-bending effects. This is because the principles that govern macro-bending are different from the principles that govern micro-bending. Also, the design considerations for single-core fibers sometimes differ from the design consideration for multi-core fibers because different types of fibers are affected, sometimes unpredictably, by various design parameters.

### SUMMARY

The present disclosure teaches optical fibers with multiple cores (also designated as multi-core optical fibers or, simply, multi-core fibers (MCF)). For some embodiments, an optical fiber comprises a central axis (designated arbitrarily as z-axis or, simply, z), along which an optical signal is transmitted. The optical fiber further comprises a cladding that extends along z. The cladding comprises a substantially circular axial cross section (with a cladding center and a cladding outer diameter (ODclad)). For some embodiments, ODclad is between approximately eighty (80) micrometers (μm) and approximately 300 μm (also designated as 80 μm≤ODclad≤300 μm). Preferably, 100 μm≤ODclad≤240 μm, with even more preferable embodiments having 125 μm≤ODclad≤200 μm or 125 μm≤ODclad≤150 μm. In some preferred embodiments, the ODclad is approximately 100 μm or 125 μm (meaning ODclad≈100 μm or ODclad≈125 μm).

The optical fiber further comprises a coating that is disposed about the cladding. The coating has an outer diameter (ODcoat) that will depend on the ODclad. Preferably, the thickness of the coating ranges from 0 μm (meaning no coating) to approximately 200 μm, thereby making an acceptable range for ODcoat to be between approximately 80 μm and approximately 700 μm (meaning, 80 μm≤ODcoat≤700 μm). For some embodiments (such as when ODclad≈125 μm) the ODcoat≈245 μm or ODcoat≈200 μm, while for other embodiments (such as when ODclad≈100 μm) ODcoat≈200 μm or where the coating thickness is further decreased so that ODcoat≈180 μm or even ODCoat≈160 μm. It should be noted that the optical fiber becomes more susceptible to micro-bend effects as ODcoat decreases or ODclad decreases.

Because the optical fiber is a MCF, the optical fiber also comprises at least a first core disposed within the cladding and a second core disposed within the cladding. To comply with industry standards for single-mode fibers (SMFs), each core (e.g., first core, second core, etc.) of the MCF 100 has a maximum polarization mode dispersion (PMD) coefficient of 0.1 picoseconds-per-square-root-kilometer (ps/√km). Preferably, the maximum PMD coefficient is 0.04 ps/√km (for example, when a minimum length of fiber taken off a spool is ˜500 meters (m) or more). Even more preferably, the maximum PMD coefficient is 0.02 ps/√km (when minimum length of fiber taken off spool is ˜500 m).

The optical fiber exhibits cross-talk from cross-coupling between the first core and the second core. The cross-talk increases under micro-bend conditions. To mitigate for the increased cross-talk due to micro-bending, the optical fiber is twisted about the z-axis and, thus, exhibits a twist (comprising a twist period of τ). Due to this twist, at least one core (e.g., first core) becomes disposed helically about z to form a helical core with a helical pitch (p). Because the MCF is twisted about the z-axis, and because the first core is disposed within the cladding, p is approximately equal to τ, meaning that p≈τ. For some embodiments, the second core is a central core that extends substantially along z and comprises a spin with a period of τ (because of the twist on the optical fiber). For other embodiments, the second core is a second helical core, which, similar to the first helical core, has a pitch of p≈τ.

The twist limits a maximum amount of increased cross-talk. In some embodiments, the maximum amount of increased cross-talk is limited to less than approximately ten decibels (˜10 dB) in a wavelength (λ) range of between approximately 1260 nanometers (nm) and 1360 nm (1260 nm<λ<1360 nm), which is known in the industry as the O-Band (for original band). In other embodiments, the maximum amount of increased cross-talk is limited to less than ˜6 dB for 1530 nm<λ<1565 nm, which is known in the industry as the C-band (for conventional band).

To limit the maximum amount of increased cross-talk, some embodiments twist the optical fiber so that τ is less than 9.1 centimeters (meaning, τ<9.1 cm). In other words, the optical fiber exhibits more than eleven (>11) twists-per-meter (or spins-per-meter (spins/m)), which is higher than previously recognized twist rates (or spin rates). This is because high spin rates (or high twist rates), such as fifty (50) spins/m (translating to τ≤2 cm), result in a rapid decrease of fiber quality and subsequent breaks during fiber draw.

For this reason, preferred embodiments of the disclosed optical fiber have spin rates of τ>2.5 cm (translating to fewer than forty (<40) spins/m), with a preferable range being 2.9 cm<τ<6.7 cm (which translates to ˜15≤spins/m≤˜35). A more preferable embodiment comprises 3.3 cm<τ<5.0 cm (translating to ˜20≤spins/m≤˜30). Several embodiments of the disclosed twisted MCFs were tested with 3.4 cm<τ<4.0 cm (meaning, a narrow range of ˜25≤spins/m˜29), which showed successful mitigation of micro-bend-induced cross-talk.

Broadly speaking, a twist with a twist period (τ) is imparted on the optical fiber about z. The twist mitigates micro-bend-induced cross-talk. The cladding comprises a substantially circular axial cross section. The substantially circular axial cross-section comprises a cladding center and a cladding outer diameter (ODclad). Multiple cores (e.g., a first core, a second core, etc.) are disposed within the cladding. At least one core is disposed helically about z to form a helical core, with the helical core comprising a helical pitch (p), such that p≈τ and τ<9.1 cm.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a cross-sectional axial view of one embodiment of a multi-core optical fiber, with axes designated as x-axis (horizontal) and y-axis (vertical).

FIG. 1B is a transverse view of the multi-core optical fiber shown in FIG. 1A, with axes designated as y-axis (vertical) and z-axis (along the transmission pathway).

### DETAILED DESCRIPTION OF THE EMBODIMENTS

As demand for optical fiber transmission capacity increases with global data traffic, there are ongoing efforts to deploy increasing numbers of optical fibers in fiber-optic cables. For example, by decreasing the outer diameter (OD) of an optical fiber, a fiber-optic cable can carry more fibers, thereby increasing the fiber density within a cable duct.

One approach to increasing transmission capacity is to employ spatial division multiplexing (SDM) in multi-core optical fibers (or multi-core fibers (MCF)). Unlike single-core optical fibers (or single-mode fibers (SMF)), MCFs have multiple cores within the same cladding. Because cores in the MCF are close in proximity, cross-coupling between neighboring cores can result in inter-core cross-talk, which is an impairment that is not present in SMFs. The inter-core cross-talk degrades signal quality and, therefore, limits reach or data capacity of MCFs.

As one can appreciate, inter-core cross-talk can be reduced by increasing the spacing between neighboring cores. However, the increase in spacing while keeping the outer cladding thickness (OCT) unchanged increases the OD of the MCF, thereby decreasing fiber density. In other words, there is a trade-off between decreasing OD and increasing inter-core spacing in MCF. Alternatively, if the increase in core spacing is done without the increase in OD, the OCT will decrease, thereby increasing excess loss of outer cores and creating a trade-off between cross-talk and fiber loss. There are additional trade-offs for improved cross-talk, such as, for example, attenuation, mode field diameter (MFD), cut-off wavelength, and manufacturing costs (in addition to fiber density).

One of the many confounding factors in inter-core cross-talk is the impact of both macro-bending and micro-bending on cross-talk. Fiber cabling and actual field deployment conditions can have strong influences on actual cross-talk due to both macro-bending and micro-bending.

As appreciated by those having skill in the art, industry standards for optical fibers includes macro-bending losses as part of the fiber specifications. Consequently, macro-bending losses are routinely and easily tested during factory fiber qualification. Unlike macro-bending, micro-bending is not addressed in fiber specifications. Also, micro-bending losses are more difficult and time consuming to characterize than macro-bending losses. Furthermore, unlike macro-bending tests (which are performed by wrapping optical fibers around mandrels of various diameters or bending the optical fibers in some other way), micro-bending tests are often performed on nominally straight optical fibers without bends. Some examples of measuring micro-bending sensitivity are set forth in the International Electrotechnical Commission (IEC) Technical Report (TR) 62221 Ed. 2.0:2012, having the title “Optical Fibres—Measurement Methods—Microbending Sensitivity,” which is familiar to those having skill in the art. Because of these differences between macro-bending and micro-bending, approaches to mitigating macro-bending losses are not directly translatable to micro-bending.

Because of the trade-offs between attenuation, MFD, cut-off wavelength, manufacturing costs, fiber count (or fiber density), macro-bending effects on cross-talk, and micro-bending effects on cross-talk, as well as a host of other effects (e.g., polarization mode dispersion (PMD)), it is not a simple or trivial task to mitigate micro-bending cross-talk effects that do not negatively impact other transmission-influencing parameters.

The disclosed embodiments seek to mitigate for micro-bending effects on cross-talk by imparting a twist (or a spin) on a MCF. Specifically, the twist period (τ) that is applied to the MCF is less than 9.1 centimeters (cm), which translates to greater than eleven (11) twists-per-meter. Such a small τ<9.1 cm is far less than spin rates that have been used conventionally to mitigate for macro-bending losses. This is because a higher spin rate (or higher twist rate) increases a likelihood of breaks during fiber draw or undesirable mechanical twists when handling the fiber off a spool.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents. It should be appreciated that spin and twist are used interchangeably in this disclosure and, similarly, spin rates and twist rates are used interchangeably in this disclosure, unless indicated otherwise expressly or by context.

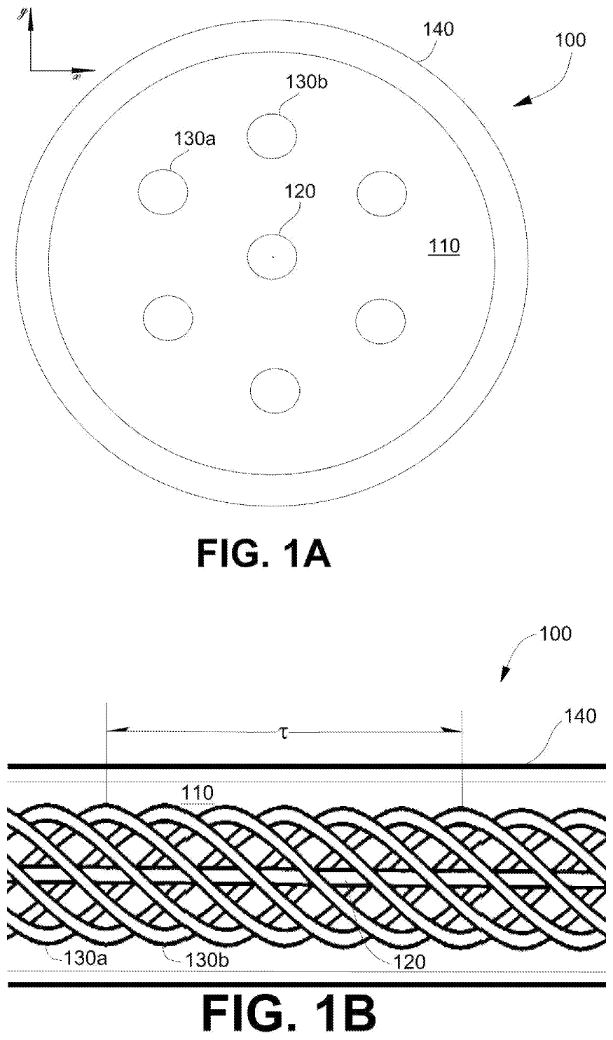

Turning to FIG. 1A and FIG. 1B (collectively designated as FIG. 1), the present disclosure teaches an optical fiber 100 (shown as a MCF) with a central axis (designated arbitrarily as z-axis or, simply, z), along which an optical signal is transmitted. Specifically, FIG. 1A shows a cross-sectional axial view of one embodiment of the MCF 100, while FIG. 1B shows a transverse view of the MCF 100. The optical fiber 100 comprises a cladding 110 that extends along z. The cladding 110 comprises a substantially circular axial cross section (with a cladding center and a cladding outer diameter (ODclad)). For some embodiments, ODclad is between approximately eighty (80) micrometers (μm) and approximately 300 μm (also designated as 80 μm≤ODclad≤300 μm). Preferably, 100 μm≤ODclad≤240 μm, with even more preferable embodiments having 125 μm≤ODclad≤200 μm or 125 μm≤ODclad≤150 μm. In some preferred embodiments, the ODclad is approximately 100 μm or 125 μm (meaning ODclad≈100 μm or ODclad≈125 μm).

Because the optical fiber 100 is a MCF, the optical fiber 100 also comprises multiple cores 120, 130a, 130b. In the embodiment of FIG. 1, the MCF comprises a central core 120 and peripheral cores (such as a first peripheral core 130a and a second peripheral core 130b. The central core 120, the first peripheral core 130a, and the second peripheral core 130b are disposed within the cladding 110. To comply with industry standards, each core (e.g., the central core 120 and the peripheral cores 130a, 130b (collectively designated as 130)) has a maximum polarization mode dispersion (PMD) coefficient of 0.1 picoseconds-per-square-root-kilometer (ps/√km). Preferably, the maximum PMD coefficient is 0.04 ps/√km (for example, when a minimum length of fiber taken off a spool is ˜500 meters (m) or more). For other preferred embodiments, the maximum PMD coefficient (when a minimum length of ˜500 m is taken off a spool) is 0.02 ps/√km.

The optical fiber 100 further comprises a coating 140 that is disposed about the cladding 110. The coating 140 has an outer diameter (ODcoat). Preferably, the thickness of the coating ranges from 0 μm (meaning no coating) to approximately 200 μm, thereby making an acceptable range for ODcoat to be between approximately 80 μm and approximately 700 μm (meaning, 80 μm≤ODcoat≤700 μm). For some embodiments (such as when ODclad≈125 μm) the ODcoat≈245 μm, while for other embodiments (such as when ODclad≈100 μm) ODcoat≈200 μm. It should be noted that the optical fiber becomes more susceptible to micro-bend effects as ODcoat decreases or ODclad decreases.

The optical fiber 100 exhibits cross-talk from cross-coupling between the first core 130a and the second core (whether it be a central-core-to-peripheral-core cross-talk or a peripheral-core-to-peripheral-core cross-talk). The cross-talk increases under micro-bend conditions. To mitigate for the increased cross-talk due to micro-bending, the optical fiber 100 is twisted about the z-axis and, thus, exhibits a twist (comprising a twist period of τ). Due to this twist, at least one core (e.g., first core 130a) becomes disposed helically about z to form a helical core with a helical pitch (p), as shown in FIG. 1B.

Because the MCF 100 is twisted about the z-axis, and because the first core 130a is disposed within the cladding 110, p is approximately equal to τ, meaning that p≈τ. For some embodiments, the second core is a central core 120 that extends substantially along z and comprises a spin with a period of τ (because of the twist on the optical fiber). For other embodiments, the second core is a second helical core 130b, which, similar to the first helical core 130a, has a pitch of p≈τ.

The twist limits a maximum amount of increased cross-talk between the neighboring cores. In some embodiments, the maximum amount of increased cross-talk is limited to less than approximately ten decibels (˜10 dB) in a wavelength (λ) range of between approximately 1260 nanometers (nm) and 1360 nm (1260 nm<λ<1360 nm), which is known in the industry as the O-Band (for original band). In other embodiments, the maximum amount of increased cross-talk is limited to less than ˜6 dB for 1530 nm<λ<1565 nm, which is known in the industry as the C-band (for conventional band).

To limit the maximum amount of increased cross-talk, some embodiments twist the optical fiber 100 so that τ is less than 9.1 centimeters (meaning, τ<9.1 cm). In other words, the optical fiber 100 exhibits more than eleven (>11) twists-per-meter (or spins-per-meter (spins/m)), which is higher than previously recognized twist rates (or spin rates). This is because high spin rates (or high twist rates), such as fifty (50) spins/m (translating to τ≤2 cm), result in a rapid decrease of fiber quality and subsequent breaks during fiber draw.

For this reason, preferred embodiments of the disclosed optical fiber 100 have spin rates of τ>2.5 cm (translating to fewer than forty (<40) spins/m), with a preferable range being 2.9 cm<τ<6.7 cm (which translates to ˜15≤spins/m≤˜35). A more preferable embodiment comprises 3.3 cm<τ<5.0 cm (translating to ˜20≤spins/m≤˜30). Several embodiments of the disclosed twisted MCFs were tested with 3.4 cm<τ<4.0 cm (meaning, a narrow range of ˜25≤spins/m˜29), which showed successful mitigation of micro-bend-induced cross-talk.

The spinning or twisting of the optical fiber 100 produces additional benefits, such as further reduction and stabilization of PMD. Because MCFs have non-symmetric structures, the cladding 110 around the cores 120, 130 invariably exhibits substantial frozen-in thermal stress from the draw process. This is often an order of magnitude higher than the thermal stress in standard SCFs. This stress causes optical birefringence, which is the cause of PMD. With the spin period being less than 9.1 cm, micro-bending effects on cross-talk can be reduced while concurrently reducing PMD.

Experimentally, embodiments of the disclosed MCFs 100 were tested at 3.4 cm<τ<4.0 cm (meaning, a narrow range of ˜25≤spins/m˜29) and compared to un-spun (or un-twisted) fibers. The un-spun (or un-twisted) optical fiber exhibited an increase in inter-core cross-talk of ˜17 dB/km in the O-Band and ˜6 dB/km in the L-Band (for long-wavelength band, which is 1565 nm≤λ≤1625 nm) under micro-bending conditions (as compared to no micro-bending applied). Unlike the un-spun (or un-twisted) optical fibers, the twisted optical fibers 100 exhibited an increase in inter-core cross-talk of only ˜7 dB/km in the O-Band and ˜4 dB/km in the L-Band under micro-bending conditions (as compared to no micro-bending applied). Thus, the experimental results showed an improvement of ˜10 dB/km in the O-Band and ˜2 dB/km in the L-Band for τ of between ˜25 and ˜29 spins/m.

In other implementations, the micro-bending loss of the optical fiber 100 decreased by approximately 0.04 dB/km, as averaged over all cores 120, 130.

Measuring PMD coefficient values in both twisted and un-twisted optical fibers, an optical fiber with a twist of ˜30 spins/meter (or τ≈3.3 cm) improved the PMD. For example, an un-twisted optical fiber exhibited a measured PMD coefficient of up to ˜0.3 ps/√km (e.g., ˜0.28 ps/√km) when tested on a spool, while exhibiting a measured PMD coefficient of up to ˜4.8 ps/√km (e.g., ˜4.33 ps/√km) when removed from the spool. The latter value continued to increase proportionally with longer unspooled fiber lengths. This demonstrated that cable-deployment could increase PMD-related signal impairment.

To compare the un-twisted optical fiber with the twisted optical fiber, at a spin rate of ˜30 spins/meter (τ≈3.3 cm), the PMD coefficient went from 0.28 ps/√km (for un-twisted optical fiber on the spool) to 0.028 ps/√km (for twisted optical fiber on the spool), which is an improvement of one (1) order of magnitude. The off-spool comparison resulted in an even greater improvement, with the off-spool PMD coefficient going from ˜4.33 ps/√km (for un-twisted optical fiber) down to ˜0.03 ps/√km (for twisted optical fiber at τ=3.3 cm), which is an improvement of over two (2) orders of magnitude. Significantly, the on-spool and off-spool PMD values became essentially the same, which demonstrates that low PMD in twisted optical fibers may be fully preserved during MCF cabling and field deployment. Furthermore, unlike most current transmission optical fibers, the PMD on twisted MCFs can be accurately measured on-spool, which no longer requires a low-mode-coupled approach that is typically used in production.

It is further noted that the high spin rates, as described above, did not introduce significant impairments to other key parameters (e.g., core density, cut-off wavelength, MFD, attenuation, coating quality, fiber strength, etc.). Additionally, imparting such a twist or spin on the MCF did not require any specialized equipment and was accomplished by standard draw tower equipment.

Ultimately, depending on the degree of birefringence in the MCF, spin conditions may require additional optimization or adjustment (as compared to SMFs). However, the maximum spin rates (e.g., τ≈2.5 cm) are achievable with standard draw tower equipment.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An optical fiber, comprising:
a central axis (z);
a cladding extending along z, the cladding comprising a substantially circular axial cross section, the substantially circular axial cross section comprising a cladding center, the substantially circular axial cross section further comprising a cladding outer diameter (ODclad);
a twist about z, the twist having a period (τ) that is less than 9.1 centimeters (τ<9.1 cm);
a first core disposed within the cladding, the first core being disposed helically about z to form a helical core, the helical core comprising a helical pitch (p) that is approximately equal to τ (p≈τ); and
a second core disposed within the cladding;
cross-talk from cross-coupling between the first core and the second core, the cross-talk increasing under micro-bend conditions to a maximum amount of increased cross-talk, the maximum amount of increased cross-talk being limited by the twist; and
a coating disposed about the cladding, the coating comprising a coating outer diameter (ODcoat).

2. The optical fiber of claim 1, wherein the second core is a central core extending substantially along z, the central core comprising a spin with a period of τ.

3. The optical fiber of claim 1:
wherein the first core is a first helical core; and
wherein the second core is disposed helically about z to form a second helical core.

4. The optical fiber of claim 1:
wherein the first core comprises a maximum polarization mode dispersion (PMD) coefficient of 0.1 picoseconds-per-square-root-kilometer (ps/√km).

5. The optical fiber of claim 4, wherein the maximum PMD coefficient is 0.04 ps/√km.

6. The optical fiber of claim 4, wherein the maximum PMD coefficient is 0.02 ps/√km.

7. The optical fiber of claim 1:
wherein the second core comprises a maximum polarization mode dispersion (PMD) coefficient of 0.1 picoseconds-per-square-root-kilometer (ps/√km).

8. The optical fiber of claim 7, wherein the maximum PMD coefficient is 0.04 ps/√km.

9. The optical fiber of claim 7, wherein the maximum PMD coefficient is 0.02 ps/√km.

10. The optical fiber of claim 1, wherein the maximum amount of increased cross-talk is limited to less than approximately ten decibels (˜10 dB) in a wavelength (λ) range of between approximately 1260 nanometers (nm) and 1360 nm (1260 nm<λ<1360 nm).

11. The optical fiber of claim 1, wherein the maximum amount of increased cross-talk is limited to less than approximately six decibels (˜6 dB) in a wavelength (λ) range of between approximately 1530 nanometers (nm) and 1565 nm (1530 nm<λ<1565 nm).

12. The optical fiber of claim 1, wherein ODclad is between approximately eighty (80) micrometers (μm) and approximately 300 μm (˜80 μm≤ODclad≤˜300 μm).

13. The optical fiber of claim 12, wherein ODclad is approximately equal to 125 μm (ODclad≈125 μm).

14. The optical fiber of claim 1, wherein ODcoat is between approximately 80 micrometers (μm) and approximately 700 μm (80 μm≤ODcoat≤700 μm).

15. The optical fiber of claim 14, wherein ODcoat≈245 μm.

16. The optical fiber of claim 14, wherein ODcoat≈200 μm.

17. The optical fiber of claim 1, wherein τ is greater than 2.5 cm (τ>2.5 cm).

18. The optical fiber of claim 17, wherein τ is between 2.9 cm and 6.7 cm (2.9 cm<τ<6.7 cm).

19. The optical fiber of claim 18, wherein 3.3 cm<τ<5.0 cm.

20. The optical fiber of claim 19, wherein 3.4 cm<τ<4.0 cm.
